(19) United States
(12) Patent Application Publication
(10) Pub. No.: US 2012/0321311 A1
(43) Pub. Date: Dec. 20, 2012

(54) Coherent Interleaved Polarization-Multiplexing Optical Communications with Single IQ Modulator

(75) Inventors: Shaoliang Zhang, Plainsboro, NJ (US); Fatih Yaman, Monmouth Junction, NJ (US); Lei Xu, Princeton Junction, NJ (US); Ting Wang, West Windsor, NJ (US); Yoshihisa Inada, Tokyo (JP); Takaaki Ogata, Tokyo (JP); Yasuhiro Aoki, Tokyo (JP)

(73) Assignee: NEC LABORATORIES AMERICA, INC., Princeton, NJ (US)

(21) Appl. No.: 13/523,045

(22) Filed: Jun. 14, 2012

Related U.S. Application Data
(60) Provisional application No. 61/497,988, filed on Jun. 17, 2011.

(51) Int. Cl. H04J 14/06

(52) U.S. Cl. 398/65

(57) ABSTRACT

An inventive method for coherent interleaved polarization-multiplexing PolMux optical communications with a single IQ modulator includes modulating a light source to generate a 50% return-to-zero RZ signal pulse at a frequency Rs, driving a single IQ modulator with inphase I and quadrature phase Q data at a bit rate of sais Rs to introduce phase modulation on said 50% RZ signal pulse to produce a QPSK pulse signal with all symbols being in a same polarization state without any time overlapping; and polarization modulating said QPSK signal to alternatively convert said QPSK signal into two orthogonal polarizations states enabling an interleaving PolMux signal with a symbol rate of Rs/2.

This application claims the benefit of U.S. Provisional Application No. 61/497,988, entitled “Coherent Interleaved Polarization-Multiplexing Optical Communication Systems with Single IQ Modulator”, filed Jun. 17, 2011, of which the contents are incorporated herein by reference.

### BACKGROUND OF THE INVENTION

The present invention relates generally to optical communications and more particularly to a Coherent Interleaved Polarization-Multiplexing Optical Communications with Single IQ Modulator.

Coherent detection has been recognized as the ideal receiving scheme for improving receiver sensitivity and spectrum efficiency. It is capable of acquiring the full field of the received optical signals, such as polarization, phase and amplitude, thus enabling the advanced modulation techniques and digital signal processing (DSP) algorithms. For example, polarization multiplexing (PolMux) can double the spectrum efficiency in principle without extra bandwidth.

Nowadays one of the major challenges facing high-speed optical networks is to increase the fiber nonlinearity tolerance, which can be partially addressed through deploying large-effective-area fibers and applying sophisticated DSP algorithms in coherent receivers. However, the PolMux would actually enhance the fiber nonlinearity effects, especially in dispersion-managed fibers. The aligned symbols in two polarization states would interact strongly because of nonlinear polarization scattering, thus leading to severe performance degradation in a dispersion-managed system. It is suggested in literatures to use time-interleaving PolMux instead of aligned PolMux to mitigate the fiber nonlinearity effect. In experiments, two IQ modulators and polarization beam splitter/combiner are used to generate interleaved PolMux signals. In this invention record, we propose a simple way to generate time-interleaved PolMux signals without any timing overlapping.

In a known existing scheme, the laser output is split into two polarization states for independent data modulation through TWO IQ modulators. The signal in one polarization state is shifted by a half-symbol delay and is then combined with the other signals from the other polarization state through polarization beam combiner to generate the interleaved PolMux signals. However, this scheme does not address minimizing the fiber nonlinearity effects by PolMux.

Accordingly, there is a need for an improved PolMux technique that minimizes optical fiber nonlinear distortions.

### BRIEF SUMMARY OF THE INVENTION

The present inventive method for coherent interleaved polarization-multiplexing PolMux optical communications with a single IQ modulator includes modulating a light source to generate a 50% return-to-zero RZ signal pulse at a frequency Rs, driving a single IQ modulator with inphase I and quadrature phase Q data at a bit rate of sais Rs to introduce phase modulation on said 50% RZ signal pulse to produce a QPSK pulse signal with all symbols being in a same polarization state without any time overlapping; and polarization modulating said QPSK signal to alternatively convert said QPSK signal into two orthogonal polarizations states enabling an interleaving PolMux signal with a symbol rate of Rs/2.

These and other advantages of the invention will be apparent to those of ordinary skill in the art by reference to the following detailed description and the accompanying drawings.

### BRIEF DESCRIPTION OF THE DRAWINGS

FIG. 1 is a diagram of an exemplary a fully time-interleaving polarization multiplexing PolMux coherent optical communications configuration operating at a symbol rate of Rs, in accordance with the invention;

FIG. 2 is a flowchart for the coherent receiver for the fully time-interleaving PolMux configuration of FIG. 1, in accordance with the invention; and

FIG. 3 is a block diagram of key aspects of the inventive fully time-interleaving polarization multiplexing PolMux coherent optical communications.

### DETAILED DESCRIPTION

The present invention is directed to the use of one I/Q modulator plus a polarization modulator to generate interleaved PolMux signals, instead of using two I/Q modulators with polarization splitter/combiner. Advantageously, with the present invention the signals in two polarization states are fully time interleaved; therefore, the inter-symbol interference between the two neighboring symbols does not generate coherent beating, and thus suffers from reduced nonlinear distortions. The I/Q modulator in the inventive approach needs to operate at twice speed as fast as that in a polarization-multiplexing/interleaving operation.

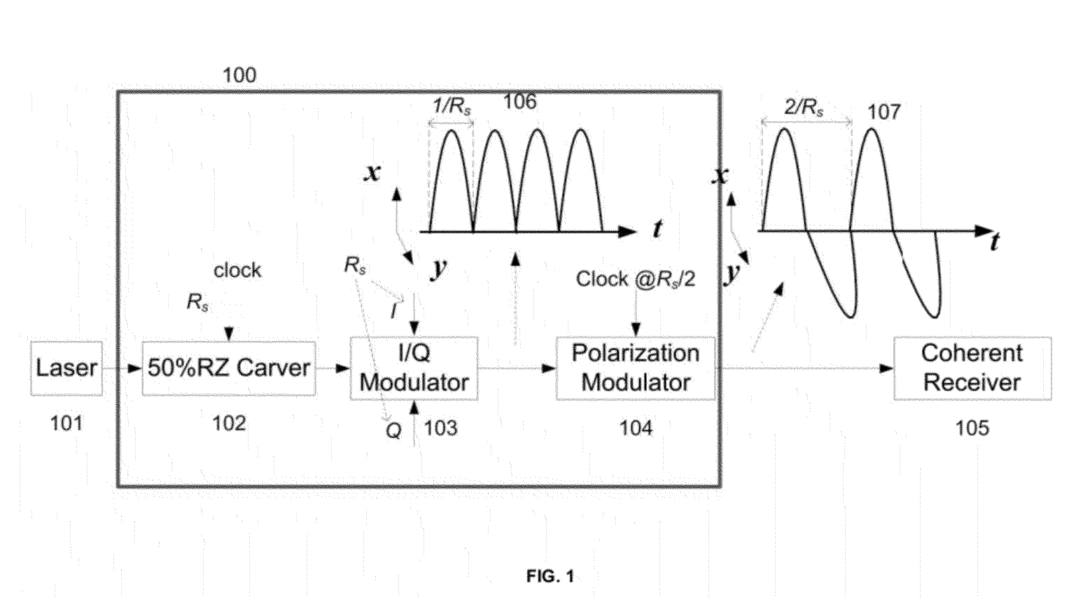

Referring now to the diagram of FIG. 1, to generate interleaved PolMux QPSK signals, the laser output (101) is modulated by Mach-Zehnder modulator (MZM, 102) to generate 50% RZ signal pulse at frequency R_{S}. Then inphase and quadrature data drive IQ modulator (103) at R_{S} bit rate to introduce phase modulation on the 50% RZ pulse train (106). Note that all the symbols are in the same polarization state without any time overlapping. A polarization modulator (104) is applied to the QPSK pulse train (106) to alternatively convert it into two orthogonal polarization states (107), enabling interleaving PolMux at symbol rate of R_{S}/2. In other words, there is a need to double the modulation speed of the transmitter to obtain the same symbol rate as in conventional approach using two IQ modulators. As a result, the polarization states of two consecutive symbols are orthogonal without time overlapping. This is the our proposed transmitter for generating no-time-overlapping interleaved polarization multiplexing signals, as enclosed in Block 100 of FIG. 1.

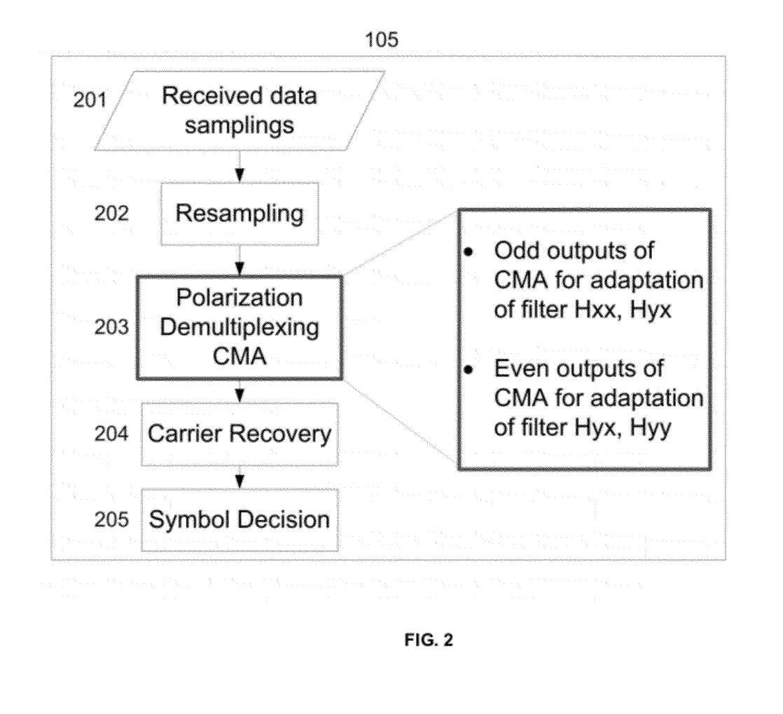

Turning now to the flowchart of FIG. 2, in coherent receiver (105), modified DSP steps are performed to recover the data at both polarization states. FIG. 2 illustrates the detail signal processing in the coherent receiver (105). The received signal samples (201) from the front-end of coherent receiver will be resampled into 2 samples per symbol (202), where the applied symbol rate is R_{S}/2. Generally, conventional approaches in the polarization de-multiplexing algorithm, such as constant modulus algorithm (CMA), are utilized to separate two polarization states (203). In conventional CMA algorithm, either odd or even samples are exploited to adapt the four CMA filters. In this proposal, we take into account the non-overlapping characteristics of this special transmitter, so that we use the odd output of CMA, corresponding to the samples from x-polarization, to adapt the CMA filters in x-polarization. And then the even output of CMA, which can be regarded as the samples from y-polarization, is used for adaptation of CMA filters in the same polarization state (203). After separating the two polarization states, the carrier recovery module (204) and symbol decision (205) are performed to recover the original transmitted data.

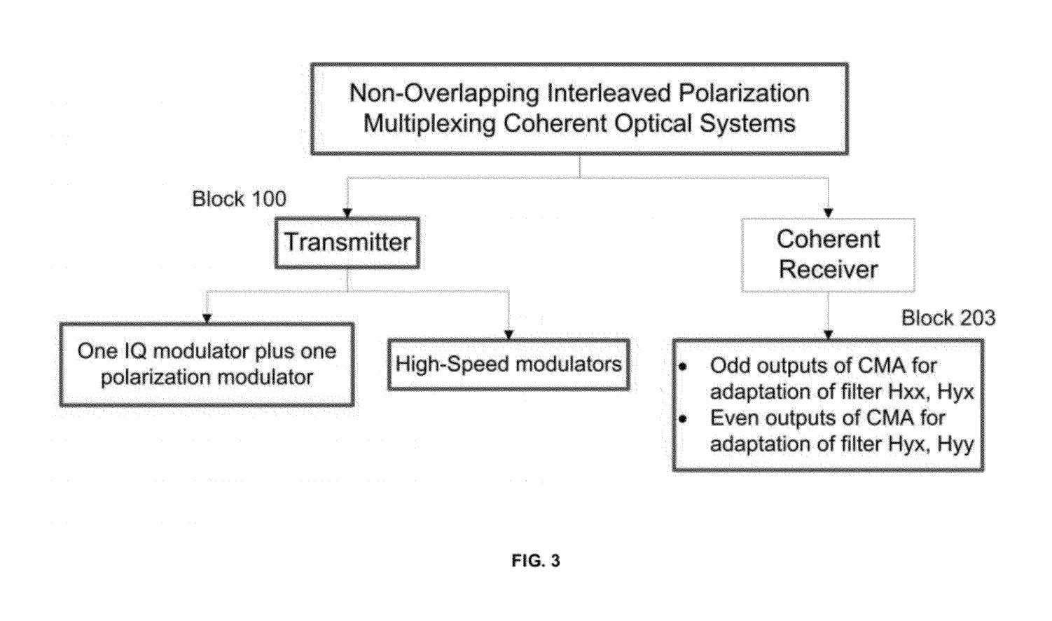

Referring now to the block diagram of FIG. 3, key aspects of the present invention are highlighted. The inventive non-overlapping interleaved polarization multiplexing coherent Optical approach entails the transmitter 100 and coherent receiver 105. The transmitter entails only one IQ modulator plus one polarization modulator and high-speed modulators. The coherent receiver's key aspects are: odd outputs of CMA for adaptation filter H_{XX}, H_{YX}, and even outputs of CMA for adaptation filter H_{YX}, H_{YY}.

From the foregoing, it can be appreciated that two IQ modulators and polarization beam splitter/combiner are necessary to support independent modulation in either aligned or interleaved polarization multiplexing optical systems. The symbol in the orthogonal polarization state has been shifted by half symbol period in interleaved PolMux scheme. Note that overlapping would occur to cause crosstalk if nonlinear polarization scattering is present in a system. With the inventive approach, only one IQ modulator and a polarization modulator are used to obtain non-overlapping time-interleaved polarization multiplexing signals at the expense of high-speed IQ modulator. It is expected to have an improved nonlinearity tolerance.

The dual-polarization optical signal generated using a single IQ modulator and one polarization switching modulator can be detected with conventional direct detection. Here, it is shown that the specially configured digital coherent receiver can be used to recover the signal and can have a greater improved performance. The CMA process has been modified according to the characteristics of the non-overlapping interleaving signals. The odd output of CMA is used to adapt the CMA filters in x-polarization, and then the even output of CMA is employed for adaptation of CMA filters in the same polarization state.

From the foregoing, it can be further appreciated that the invention can reduce the complexity and the cost of generating polarization-multiplexed, bit-interleaved optical signals in a dual-polarization digital coherent optical communication system. With the invention, the generated polarization multiplexed optical signals can have “perfect” interleaving of the optical signals in two orthogonal polarizations. In comparison, the conventional dual-polarization, bit-interleaved optical signals may have overlapping of the “tails” of the optical signals in two polarizations at 50% pulse duty-cycle.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A method for coherent interleaved polarization-multiplexing PolMux optical communications with a single IQ modulator, comprising the steps of;
modulating a light source to generate a 50% return-to-zero RZ signal pulse at a frequency Rs;
driving a single IQ modulator with inphase I and quadrature phase Q data at a bit rate of sais Rs to introduce phase modulation on said 50% RZ signal pulse to produce a QPSK pulse signal with all symbols being in a same polarization state without any time overlapping; and
polarization modulating said QPSK signal to alternatively convert said QPSK signal into two orthogonal polarizations states enabling an interleaving PolMux signal with a symbol rate of Rs/2.

2. The method of claim 1, further comprising the step of coherent reception of a transmission of said interleaved PolMux signal at said symbol rate of Rs/2.

3. The method of claim 2, wherein said coherent reception comprises received signal samples from a front-end of said coherent reception being resampled into 2 samples per symbol where the applied symbol rate is R_{S}/2.

4. The method of claim 2, wherein said coherent reception comprises taking into account non-overlapping characteristics said transmitted interleaved PolMux signal so said reception uses an odd output of a polarization de-multiplexing process, corresponding to samples from an x-polarization, to adapt the filters of said polarization de-multiplexing process in said x-polarization state.

5. The method of claim 2, wherein said coherent reception comprises taking into account non-overlapping characteristics said transmitted interleaved PolMux signal so said reception uses an even output of a polarization de-multiplexing process, corresponding to samples from an y-polarization, to adapt the filters of said polarization de-multiplexing process in y-polarization state.

6. The method of claim 4, wherein said a polarization de-multiplexing process comprises a constant modulus process.

7. The method of claim 5, said a polarization de-multiplexing process comprises a constant modulus process.

8. The method of claim 1, wherein said modulating and polarization modulating perform at twice a speed compared to convention modulations to generate time-interleaved PolMux signals with independent modulation.

8. The method of claim 1, wherein said step of applying a polarization modulation to said QPSK signal enables doubling of a modulation speed of a transmitter to obtain the same symbol rate as in a conventional approach using two IQ modulators.

9. The method of claim 1, wherein said modulating and polarization modulating are only modulations needed for generating the non-overlapping time-interleaved PolMux signals.

10. The method of claim 1, wherein said step of applying a polarization modulation to said QPSK signal enables polarization states of two consecutive symbols that are orthogonal without time overlapping.
